(19) United States
(12) Patent Application Publication
(10) Pub. No.: US 2018/0331389 A1
(43) Pub. Date: Nov. 15, 2018

(54) LITHIUM ION BATTERY

(71) Applicant: GM GLOBAL TECHNOLOGY OPERATIONS LLC, Detroit, MI (US)

(72) Inventors: Haijing LIU, Shanghai (CN); Xiaochao QUE, Shanghai (CN); Meiyuan WU, Shanghai (CN); Dewen KONG, Shanghai (CN); Jianyong LIU, Shanghai (CN); Zhiqiang YU, Shanghai (CN); Shawn DENG, Shanghai (CN)

(73) Assignee: GM GLOBAL TECHNOLOGY OPERATIONS LLC, Detroit, MI (US)

(21) Appl. No.: 15/775,696

(22) PCT Filed: Nov. 20, 2015
(86) PCT No.: PCT/CN2015/095201

§ 371 Date: May 11, 2018

(51) Int. Cl. H01M 10/0525; H01M 4/505; H01M 4/525; H01M 4/62; H01M 4/66; H01M 10/42; H01M 10/0569; H01M 2/16

(52) U.S. Cl. CPC H01M 10/0525; H01M 4/505; H01M 4/525; H01M 4/623; H01M 4/625; H01M 2004/027; H01M 4/667; H01M 10/42; H01M 10/0569; H01M 2/162; H01M 4/661

(57) ABSTRACT

A lithium ion battery is provided that includes: a positive electrode; a negative electrode; and a polymer separator soaked in an electrolyte solution, the polymer separator being disposed between the positive electrode and the negative electrode. The positive electrode includes an active material of lithium manganese oxide, lithium nickel manganese cobalt oxide, or combinations thereof. The negative electrode includes lithium titanate. A method of making the lithium ion battery is also provided.

### TECHNICAL FIELD

The present disclosure relates generally to lithium ion batteries.

### BACKGROUND

Secondary, or rechargeable, lithium ion batteries are used in many stationary and portable devices, such as those encountered in the consumer electronic, automobile, and aerospace industries. The lithium ion class of batteries has gained popularity for various reasons including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

A lithium-ion battery includes a positive electrode, a negative electrode, a polymer separator disposed between the positive and negative electrodes, and an electrolyte solution soaking the polymer separator. The positive electrode includes one or both of lithium manganese oxide and lithium nickel manganese cobalt oxide as a positive electrode active material, and the negative electrode includes lithium titanate.

### BRIEF DESCRIPTION OF THE DRAWINGS

Features of examples of the present disclosure will become apparent by reference to the following detailed description and drawings, in which like reference characters correspond to similar, though perhaps not identical, components. For the sake of brevity, reference characters or features having a previously described function may or may not be described in connection with other drawings in which they appear.

FIG. 1 schematically illustrates an example of a lithium ion battery during a discharging state;

FIG. 2 is a graph, illustrating the discharge rate performance of lithium manganese oxide (LMO)/lithium titanate (LTO) and lithium nickel manganese cobalt oxide (NMC)/LTO cells, the measurements being repeated, where −1 indicates the first measurement and −2 indicates the second measurement for five different C-rates of 1 C, 10 C, 20 C, 30 C, and 50 C;

FIG. 3 is a graph depicting the recovery capacity retention versus the number of cycles for LMO/LTO cells formulated with different electrolytes; and

FIG. 4 is a graph depicting the capacity retention of NMC/LTO cells stored at 70° C. for 14 days.

### DETAILED DESCRIPTION

A lithium ion battery generally operates by reversibly passing lithium ions between a negative electrode (sometimes called an anode) and a positive electrode (sometimes called a cathode). The negative and positive electrodes are situated on opposite sides of a porous polymer separator that is soaked with an electrolyte solution suitable for conducting lithium ions. Each of the negative and positive electrodes is also accommodated by a respective current collector. The current collectors associated with the two electrodes are connected by an interruptible external circuit that allows an electric current to pass between the electrodes to electrically balance the related migration of lithium ions. Further, the negative electrode may include a lithium intercalation host material, and the positive electrode may include a lithium-based active material that can store lithium ions at a higher electric potential than the intercalation host material of the negative electrode.

Several lithium ion batteries have been developed, all with varying operating properties. Some lithium ion batteries have been developed which include a negative electrode having lithium titanate nanocrystals on the surface of thereof. While batteries with this type of lithium titanate negative electrode can be charged quickly, the battery is generally not suitable for use in cold temperatures. Further, the LTO battery has low energy density, and typically exhibits gassing issues. The LTO material is moisture sensitive, which may lead to higher manufacturing cost.

The example lithium ion batteries disclosed herein exhibit high power capability, a large operational temperature window (−30° C. to 70° C.), and long life. The present inventors have unexpectedly found that all of these parameters can be achieved simultaneously when the cells are formulated according to the combination of factors disclosed herein, each of which has been found to be associated with its own specific range.

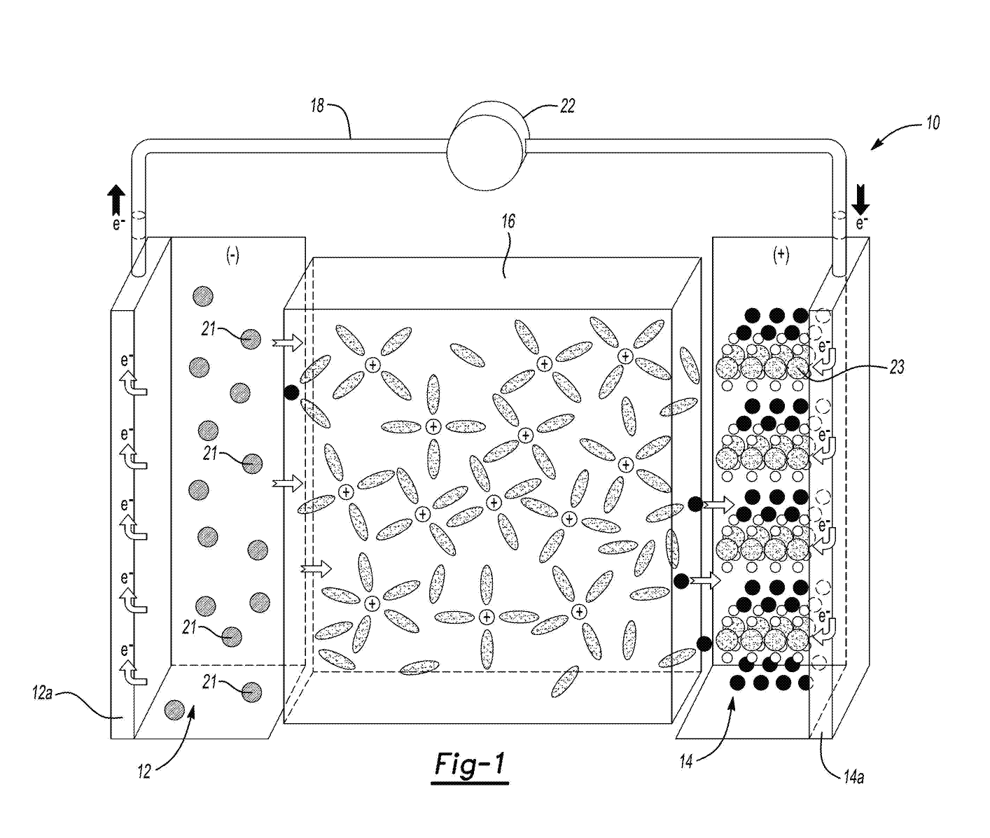

Referring now to FIG. 1, an example of a lithium ion battery 10 is illustrated. The lithium ion battery 10 generally includes a negative electrode 12, a negative-side current collector 12a, a positive electrode 14, a positive-side current collector 14a, and a polymer separator 16 disposed between the negative electrode 12 and the positive electrode 14. An interruptible external circuit 18 connects the negative electrode 12 and the positive electrode 14. Each of the negative electrode 12, the positive electrode 14, and the polymer separator 16 are soaked in an electrolyte solution capable of conducting lithium ions. The negative-side current collector 12a and the positive-side current collector 14a may be positioned in contact with the negative electrode 12 and the positive electrode 14, respectively, to collect and move free electrons to and from the external circuit 18.

The lithium ion battery 10 may support a load device 22 that can be operatively connected to the external circuit 18. The load device 22 may be powered fully or partially by the electric current passing through the external circuit 18 when the lithium ion battery 10 is discharging. While the load device 22 may be any number of known electrically-powered devices, a few specific examples of a power-consuming load device include an electric motor for a hybrid vehicle or an all-electrical vehicle, a laptop computer, a cellular phone, and a cordless power tool. The load device 22 may also, however, be a power-generating apparatus that charges the lithium ion battery 10 for purposes of storing energy. For instance, the tendency of windmills and solar panels to variably and/or intermittently generate electricity often results in a need to store surplus energy for later use.

The lithium ion battery 10 can include a wide range of other components that, while not depicted here, are nonetheless known to skilled artisans. For instance, the lithium ion battery 10 may include a casing, gaskets, terminals, tabs, and any other desirable components or materials that may be situated between or around the negative electrode 12 and the positive electrode 14 for performance-related or other practical purposes. Moreover, the size and shape of the lithium ion battery 10, as well as the design and chemical make-up of its main components, may vary depending on the particular application for which it is designed. Battery-powered automobiles and hand-held consumer electronic devices, for example, are two instances where the lithium ion battery 10 would most likely be designed to different size, capacity, and power-output specifications. The lithium ion battery 10 may also be connected in series and/or in parallel with other similar lithium ion batteries to produce a greater voltage output and current (if arranged in parallel) or voltage (if arranged in series) if the load device 22 so requires.

The lithium ion battery 10 can generate a useful electric current during battery discharge by way of reversible electrochemical reactions that occur when the external circuit 18 is closed to connect the negative electrode 12 and the positive electrode 14 at a time when the negative electrode 12 contains a sufficiently higher relative quantity of intercalated lithium. The chemical potential difference between the positive electrode 14 and the negative electrode 12 (ranging from approximately 1.5V to 5.0V, depending on the exact chemical make-up of the electrodes 12, 14) drives electrons produced by the oxidation of intercalated lithium at the negative electrode 12 through the external circuit 18 towards the positive electrode 14. Lithium ions, which are also produced at the negative electrode 12, are concurrently carried by the electrolyte solution through the polymer separator 16 and towards the positive electrode 14. The electrons flowing through the external circuit 18 and the lithium ions migrating across the polymer separator 16 in the electrolyte solution eventually reconcile and form intercalated lithium at the positive electrode 14. The electric current passing through the external circuit 18 can be harnessed and directed through the load device 22 until the level of intercalated lithium in the negative electrode 12 falls below a workable level or the need for electrical energy ceases.

The lithium ion battery 10 can be charged or re-powered at any time after a partial or full discharge of its available capacity by applying an external battery charger to the lithium ion battery 10 to reverse the electrochemical reactions that occur during battery discharge. The connection of an external battery charger to the lithium ion battery 10 compels the otherwise non-spontaneous oxidation of lithium transition metal oxide at the positive electrode 14 to produce electrons and release lithium ions. The electrons, which flow back towards the negative electrode 12 through the external circuit 18, and the lithium ions, which are carried by the electrolyte across the polymer separator 16 back towards the negative electrode 12, reunite at the negative electrode 12 and replenish it with intercalated lithium for consumption during the next battery discharge cycle.

The external battery charger that may be used to charge the lithium ion battery 10 may vary depending on the size, construction, and particular end-use of the lithium ion battery 10. Some suitable external power sources include a battery charger plugged into an AC wall outlet and a motor vehicle alternator.

As previously described, the lithium ion battery 10 generally operates by reversibly passing lithium ions between the negative electrode 12 and the positive electrode 14. In the fully charged state, the voltage of the battery 10 is at a maximum (typically in the range 1.5V to 5.0V); while in the fully discharged state, the voltage of the battery 10 is at a minimum (typically in the range 0V to 2.0V). Essentially, the Fermi energy levels of the active materials in the positive and negative electrodes 14, 12 change during battery operation, and so does the difference between the two, known as the battery voltage. The battery voltage decreases during discharge, with the Fermi levels getting closer to each other. During charge, the reverse process is occurring, with the battery voltage increasing as the Fermi levels are being driven apart. During battery discharge, the external load device 22 enables an electronic current flow in the external circuit 18 with a direction such that the difference between the Fermi levels (and, correspondingly, the cell voltage) decreases. The reverse happens during battery charging: the battery charger forces an electronic current flow in the external circuit 18 with a direction such that the difference between the Fermi levels (and, correspondingly, the cell voltage) increases.

At the beginning of a discharge, the negative electrode 12 of the lithium ion battery 10 contains a high concentration of intercalated lithium while the positive electrode 14 is relatively depleted. When the negative electrode 12 contains a sufficiently higher relative quantity of intercalated lithium, the lithium ion battery 10 can generate a beneficial electric current by way of the previously described reversible electrochemical reactions that occur when the external circuit 18 is closed to connect the negative electrode 12 and the positive electrode 14. The establishment of the closed external circuit under such circumstances causes the extraction of intercalated lithium from the negative electrode 12. The extracted lithium atoms are split into lithium ions (identified by the black dots and by the open circles having a (+) charge) and electrons (e⁻) as they leave an intercalation host at the negative electrode-electrolyte interface.

The negative electrode 12 may include lithium titanate (Li₄Ti₅O₁₂) present in an amount ranging from about 85 weight percent (wt. %) to about 95 wt. % based on a total wt. % of the negative electrode. The primary particle size of the lithium titanate is less than 2 μm. The particle size distribution of the lithium titanate has D50 of less than 10 μm and D 95 of less than 30 μm. In other words, 50% of the lithium titanate particles have a size smaller than 10 μm, and 95% of the lithium titanate particles have a size smaller than 30 μm. The BET surface area of the lithium titanate particles is less than 16 m²/g. At a C-rate of 1 C, the lithium titanate particles with these specifications exhibit a capacity ranging from about 150 mAh/g to about 170 mAh/g.

The negative electrode 12 may also include conductive filler, wherein the conductive filler is a combination of carbon, graphite, and vapor-grown carbon fiber (VGCF) or carbon nanotubes. The carbon may be present in an amount ranging from about 1 wt. % to about 6 wt. % based on the total wt. % of the negative electrode 12. The carbon conductive filler has a BET surface area greater than 50 m²/g. An example of the carbon conductive filler is SUPER P® (carbon black, available from Timcal Graphite & Carbon (Bodio, Switzerland)). The graphite may be present in an amount ranging from greater than 0 wt. % to about 3 wt. % based on the total wt. % of the negative electrode 12. The graphite conductive filler has D50 of less than 8 μm, and a BET surface area ranging from about 5 m²/g to about 30 m²/g. Commercial forms of graphite that may be used as a conductive filler in the negative electrode 12 are available from, for example, Timcal Graphite & Carbon, Lonza Group (Basel, Switzerland), or Superior Graphite (Chicago, Ill.). One specific example is TIMREX® KS6 (primary synthetic graphite from Timcal Graphite & Carbon. The vapor-grown carbon fiber or carbon nanotubes may be present in an amount ranging from greater than 0 wt. % to about 5 wt. % based on the total wt. % of the negative electrode 12. The vapor-grown carbon fiber may be in the form of fibers having a diameter ranging from about 100 nm to about 200 nm, a length ranging from about 3 μm to about 10 μm, and a BET surface area ranging from about 10 m²/g to about 20 m²/g. In an example, the vapor-grown carbon fiber is present in an amount ranging from greater than 0 wt. % to about 3 wt. % based on the total wt. % of the negative electrode 12. The carbon nanotubes may have a diameter ranging from about 8 nm to about 25 nm and a length ranging from about 1 μm to about 20 μm.

The negative electrode 12 may also include a binder present in an amount ranging from about 1 wt. % to about 8 wt. % based on the total wt. % of the negative electrode individually. In an example, the binder is present in an amount ranging from 2 wt. % to about 8 wt. % based on the total wt. % of the negative electrode 12. The binder may be polyvinylidene fluoride (PVDF), polytetrafluoroethylene (PTFE), carboxymethylcellulose sodium and polymerized styrene butadiene rubber (CMC+SBR), LA133, or LA132 or combinations thereof. LA133 is an aqueous binder that is a water dispersion of acrylonitrile multi-copolymer and LA132 is an aqueous binder, which is believed to be a triblock copolymer of acrylamide, lithium methacrylate, and acrylonitrile; both of these acrylonitrile copolymers are available from Chengdu Indigo Power Sources Co., Ltd., Sichuan, P.R.C.

One example of the composition of the negative electrode 12 includes about 89.5 wt. % lithium titanate, 3 wt. % carbon, 1 wt. % graphite, 1 wt. % vapor-grown carbon fiber, and 5.5 wt. % PVDF.

Adjacent the negative electrode 12 is the negative-side current collector 12a, which may be formed from aluminum. In an example, the aluminum may be in the form of bare aluminum foil. The thickness of the negative-side current collector 12a may range from about 15 μm to about 25 μm. In another example, the negative-side current collector 12a may be carbon-coated on at least one side. When the carbon coating is included, the thickness of the carbon coating on one side of the current collector 12a ranges from about 0.1 μm to about 2 μm.

Additional features of the negative electrode 12 include: a porosity ranging from about 28% to about 44%; a moisture content less than 700 ppm; an electrical conductivity that is less than 2 Ω·cm; a pressing density (the density after pressing the electrode) ranging from about 1.8 g/cm³ to about 2.2 g/cm³. When the negative electrode 12 is coated on one side of the current collector 12a, the capacity loading may range from about 0.28 mAh/cm² to about 0.84 mAh/cm². The moisture content may be measured by the Karl Fisher method, such as with a C30 Compact Karl Fischer Coulometer, available from Mettler Toledo International, Inc. (Columbus, Ohio).

The positive electrode 14 may be an active material of lithium manganese oxide (LiMn₂O₄, LMO), lithium nickel manganese cobalt oxide (LiNiₓCo_{y}Mn_{1-x-y}O₂, NMC), or combinations thereof, present in an amount ranging from about 85 wt. % to about 95 wt. % based on a total wt. % of the positive electrode.

The particle size distribution of the lithium manganese oxide has D50 of less than 10 μm and D95 of less than 20 μm. In other words, 50% of the lithium manganese oxide particles have a size smaller than 10 μm and 95% of the lithium manganese oxide particles have a size smaller than 20 μm. The BET surface area of the lithium manganese oxide particles ranges from about 0.4 m²/g to about 1.2 m²/g. At a C-rate of 1 C, the lithium manganese oxide particles with these specifications exhibit a capacity ranging from about 95 mAh/g to about 110 mAh/g.

The particle size distribution of the lithium nickel manganese cobalt oxide has D50 of less than 8 μm and D95 of less than 15 μm. In other words, 50% of the lithium nickel manganese cobalt oxide particles have a size smaller than 8 μm and 95% of the lithium nickel manganese cobalt oxide particles have a size smaller than 15 μm. The BET surface area of the lithium nickel manganese cobalt oxide particles ranges from about 0.4 m²/g to about 1.0 m²/g. At a C-rate of 1 C, the lithium nickel manganese cobalt oxide particles with these specifications exhibit a capacity ranging from about 135 mAh/g to about 300 mAh/g.

The positive electrode 14 may also include conductive filler, wherein the conductive filler is a combination of carbon, graphite, and vapor-grown carbon fiber or carbon nanotubes. The carbon may be present in an amount ranging from about 1 wt. % to about 6 wt. % based on the total wt. % of the positive electrode 14. The carbon conductive filler has a BET surface area greater than 50 m²/g. An example of the carbon conductive filler is SUPER P® (carbon black, available from Timcal Graphite & Carbon (Bodio, Switzerland)). The graphite may be present in an amount ranging from greater than 0 wt. % to about 3 wt. % based on the total wt. % of the positive electrode 14. The graphite conductive filler has D50 of less than 8 μm, and a BET surface area ranging from about 5 m²/g to about 30 m²/g. Commercial forms of graphite that may be used as a conductive filler in the positive electrode 14 are available from, for example, Timcal Graphite & Carbon (Bodio, Switzerland), Lonza Group (Basel, Switzerland), or Superior Graphite (Chicago, Ill.). One specific example is TIMREX® KS6 (primary synthetic graphite from Timcal Graphite & Carbon. The vapor-grown carbon fiber or carbon nanotubes may be present in an amount ranging from greater than 0 wt. % to about 5 wt. % based on the total wt. % of the positive electrode 14. The vapor-grown carbon fiber may be in the form of fibers having a diameter ranging from about 100 nm to about 200 nm, a length ranging from about 3 μm to about 10 μm, and a BET surface area ranging from about 10 m²/g to about 20 m²/g. The carbon nanotubes may have a diameter ranging from about 8 nm to about 25 nm and a length ranging from about 1 μm to about 20 μm.

The positive electrode 14 may also include a binder present in an amount ranging from about 1 wt. % to about 8 wt. % based on the total wt. % of the positive electrode 14. In an example, the binder is present in an amount ranging from 1 wt. % to about 5 wt. % based on the total wt. % of the positive electrode 14. The binder may be any of the same binders listed above, namely, polyvinylidene fluoride (PVDF), polytetrafluoroethylene (PTFE), carboxymethylcellulose sodium and polymerized styrene butadiene rubber (CMC+SBR), LA133, or LA132 or combinations thereof. One example of the composition of the positive electrode 14 includes about 88.5 wt. % LMO or NMC, 4 wt. % carbon, 1.5 wt. % graphite, 3 wt. % vapor-grown carbon fiber, and 3 wt. % PVDF.

Adjacent the positive electrode 14 is the positive-side current collector 14a, which may be formed from aluminum. The thickness of the positive-side current collector 14a may range from about 15 μm to about 25 μm. In an example, the aluminum may be in the form of foil. In another example, the positive-side current collector 14a may be carbon-coated on at least one side. When the carbon coating is included, the thickness of the carbon coating on one side of the current collector 14a ranges from about 0.1 μm to about 2 μm.

Additional features of the positive electrode 14 include: a porosity ranging from about 25% to about 35% and an electrical conductivity that is less than 2 Ω·cm. Where the positive electrode 14 is based on lithium manganese oxide, the moisture content is less than 300 ppm. Where the positive electrode 14 is based on lithium nickel manganese cobalt oxide, the moisture content is less than 500 ppm. Where the positive electrode active material is lithium manganese oxide, then the positive electrode 14 has a pressing density ranging from about 2.5 g/cm³ to about 2.9 g/cm³. Where the positive electrode active material is lithium nickel manganese cobalt oxide, then the positive electrode 14 has a pressing density ranging from about 2.7 g/cm³ to about 3.1 g/cm³. When any example of the positive electrode 14 is coated on one side of the current collector 14a, the capacity loading may range from about 0.28 mAh/cm² to about 0.84 mAh/cm².

The separator 16, which operates as both an electrical insulator and a mechanical support, is sandwiched between the negative electrode 12 and the positive electrode 14 to prevent physical contact between the two electrodes 12, 14 and the occurrence of a short circuit. The separator 16, in addition to providing a physical barrier between the two electrodes 12, 14, ensures passage of lithium ions (identified by the black dots and by the open circles having a (+) charge in FIG. 1) and related anions (identified by the open circles having a (−) charge in FIG. 1) through an electrolyte solution filling its pores. This helps ensure that the lithium ion battery 10 functions properly.

The separator 16 may be a microporous polymer separator. The porosity of the separator 16 ranges from about 40% to about 60%. The thickness of the separator 16 ranges from about 10 μm to about 30 μm.

The separator 16 includes, or in some examples is, a membrane, and this membrane may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP. Commercially available polyolefin microporous polymer separators 16 include CELGARD® 2500 (a monolayer polypropylene separator) and CELGARD® 2320 (a trilayer polypropylene/polyethylene/polypropylene separator) available from Celgard LLC. Some other commercially available separators are available from Entek International, Asahi-Kasei Corporation, Toray Industries, and SK Energy.

In another example, the membrane of the separator 16 may be formed from another polymer chosen from polyethylene terephthalate (PET), polyvinylidene fluoride (PVDF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the membrane of the separator 16 is poly(p-hydroxybenzoic acid). In yet another example, the membrane may be a combination of one of these polymers and a polyolefin (such as PE and/or PP).

In yet another example, the membrane of the separator 16 may be chosen from a combination of the polyolefin (such as PE and/or PP) and one or more of the polymers for the separator 16 listed above.

The separator 16 may contain a single layer or a multi-layer laminate fabricated from either a dry or wet process, by solvent casting, by a non-woven fiber laying process, or by any other process for making a microporous polymer membrane with properties suitable for application in Li-ion batteries. For example, a single layer of the polyolefin may constitute the entirety of the separator 16. In another example, a single layer of one or a combination of any of the polymers from which the separator 16 may be formed (e.g., the polyolefin and/or one or more of the other polymers listed above for the separator 16) may constitute the entirety of the separator 16. As another example, however, multiple discrete layers of similar or dissimilar polyolefins and/or polymers for the separator 16 may be assembled into the separator 16. In one example, a discrete layer of one or more of the polymers may be coated and/or laminated on a discrete layer of the polyolefin for the separator 16. Further, the polyolefin (and/or other polymer) layer, and any other optional polymer layers, may further be included in the separator 16 as a fibrous layer to help provide the separator 16 with appropriate structural and porosity characteristics. Still other suitable polymer separators 16 include those that have a ceramic layer attached thereto, and those that have ceramic filler in the polymer matrix (i.e., an organic-inorganic composite matrix).

Each of the negative electrode 12, the positive electrode 14, and the porous separator 16 are soaked in the electrolyte solution. It is to be understood that any appropriate electrolyte solution that can conduct lithium ions between the negative electrode 12 and the positive electrode 14 may be used in the lithium ion battery 10. In one example, the electrolyte solution may be a non-aqueous liquid electrolyte solution that includes a lithium salt dissolved in an organic solvent or a mixture of organic solvents. Skilled artisans are aware of the many non-aqueous liquid electrolyte solutions that may be employed in the lithium ion battery 10, as well as how to manufacture or commercially acquire them. Examples of lithium salts that may be dissolved in an organic solvent to form the non-aqueous liquid electrolyte solution include LiClO₄, LiAlCl₄, LiI, LiBr, LiSCN, LiBF₄, LiB(C₆H₅)₄, LiCF₃SO₃, LiN(CF₃SO₂)₂ (LiTFSI), LiN(FSO₂)₂ (LiFSI), LiAsF₆, LiPF₆, LiB(C₂O₄)₂ (LiBOB), LiBF₂(C₂O₄) (LiODFB), LiPF₄(C₂O₄) (LiFOP), LiNO₃, and mixtures thereof. These and other similar lithium salts may be dissolved in a variety of organic solvents such as cyclic carbonates (ethylene carbonate (EC), propylene carbonate (PC), butylene carbonate, fluoroethylene carbonate), linear carbonates (dimethyl carbonate, diethyl carbonate, ethylmethyl carbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1,2-diethoxyethane, ethoxymethoxyethane), cyclic ethers (tetrahydrofuran, 2-methyltetrahydrofuran), and mixtures thereof.

The electrolyte solution may also include a number of additives, such as solvents and/or salts that are minor components of the solution. Example additives include lithium bis(oxalato borate) (LiBOB), lithium difluoro oxalate borate (LiDFOB), vinylene carbonate, monofluoroethylene carbonate, propane sultone, 2-propyn-ol-methanesulfonate, methyl di-fluoro-acetate, succinic anhydride, maleic anhydride, adiponitrile, biphenyl, ortho-terphenyl, dibenzyl, diphenyl ether, n-methylpyrrole, furan, thiophene, 3,4-ethylenedioxythiophene, 2,5-dihydrofuran, trishexafluoro-iso-propylphosphate, trihydroxybenzene, tetramethoxytitanium, etc. While some examples have been given herein, it is to be understood that other additives could be used. When included, additives may make up from about 0.05% to about 5% of the composition of the electrolyte solution.

In an example, the electrolyte solution has a conductivity greater than 1.8 mS/cm measured at −30° C.

The lithium ion battery 10 as disclosed herein has a negative capacity to positive capacity ratio ranging from about 0.9 to about 1.05. The lithium ion battery 10 has an operational temperature ranging from about −30° C. to about 70° C. The lithium ion battery may be in the form of a pouch battery, a prismatic battery, or a cylindrical battery.

In an example of the method for making the negative electrode 12, the lithium titanate may be mixed with the conductive fillers and the binder(s). In an example of the method for making the positive electrode 14, the LMO and/or NMC may be mixed with the conductive fillers and the binder(s).

For each of the electrodes 12, 14, the respective components may be manually mixed by dry-grinding. After all these components are ground together, the ground components are combined with water or organic solvent (depending on the binder used) to form the dispersion/mixture. In an example, the solvent is a polar aprotic solvent. Examples of suitable polar aprotic solvents include dimethylacetamide (DMAC), N-methyl-2-pyrrolidone (NMP), dimethylformamide (DMF), dimethylsulfoxide (DMSO), or another Lewis base, or combinations thereof.

The dispersion/mixture may be mixed by milling. Milling aids in transforming the dispersion/mixture into a coatable slurry. Low-shear milling or high-shear milling may be used to mix the dispersion/mixture. The dispersion/mixture milling time ranges from about 10 minutes to about 20 hours depending on the milling shear rate. In an example, a rotator mixer is used for about 20 minutes at about 2000 rpm to mill the dispersion/mixture.

In one example of the dispersion/mixture for the negative electrode 12, the amount of the LTO ranges from about 85 wt. % to about 95 wt. % (based on total solid wt. % of the dispersion/mixture), the amount of the carbon ranges from about 1 wt. % to about 6 wt. % (based on total solid wt. % of the dispersion/mixture), the amount of the graphite ranges from greater than 0 wt. % to about 3 wt. % (based on total solid wt. % of the dispersion/mixture), the amount of the vapor-grown carbon fiber or the carbon nanotubes ranges from greater than 0 wt. % to about 3 wt. % (based on total solid wt. % of the dispersion/mixture), and the amount of the binder ranges from about 2 wt. % to about 8 wt. % (based on total solid wt. % of the dispersion/mixture). The viscosity of the dispersion/mixture for the negative electrode 12 ranges from about 1500 mPas (20 s⁻¹) to about 2500 mPas (20 s⁻¹). This viscosity, as well as all of the viscosities listed herein, is/are measured on a HAAKE™ MARS™ Modular Advanced Rheometer System, at a temperature in the range of 20° C. to 25° C. and at a shear rate of 20 s⁻¹.

In one example of the dispersion/mixture for the positive electrode 14, the amount of the LMO and/or NMC ranges from about 85 wt. % to about 95 wt. % (based on total solid wt. % of the dispersion/mixture), the amount of the carbon ranges from about 1 wt. % to about 6 wt. % (based on total solid wt. % of the dispersion/mixture), the amount of the graphite ranges from greater than 0 wt. % to about 3 wt. % (based on total solid wt. % of the dispersion/mixture), the amount of the vapor-grown carbon fiber or the carbon nanotubes ranges from greater than 0 wt. % to about 5 wt. % (based on total solid wt. % of the dispersion/mixture), and the amount of the binder ranges from about 1 wt. % to about 5 wt. % (based on total solid wt. % of the dispersion/mixture). The viscosity of the dispersion/mixture including LMO ranges from about 1500 mPas (20 s⁻¹) to about 3500 mPas (20 s⁻¹). The viscosity of the dispersion/mixture including NMC ranges from about 1500 mPas (20 s⁻¹) to about 3000 mPas (20 s⁻¹).

The respective slurry is then coated or deposited onto the respective current collector 12a, 14a. The slurry may be deposited using any suitable technique. As examples, the slurry may be cast on the surface of the current collector 12a, 14a, or may be spread on the surface of the current collector 12a, 14a, or may be coated on the surface of the current collector 12a, 14a using a slot die coater.

The deposited slurry may be exposed to a drying process in order to remove any remaining solvent and/or water. Drying may be accomplished using any suitable technique. For example, drying may be performed at an elevated temperature ranging from about 60° C. to about 130° C. In some examples, vacuum may also be used to accelerate the drying process. As one example of the drying process, the deposited slurry may be exposed to vacuum at about 120° C. for about 12 to 24 hours. The drying process results in the formation of the negative electrode 12 or the positive electrode 14.

To further illustrate the present disclosure, examples are given herein. It is to be understood that these examples are provided for illustrative purposes and are not to be construed as limiting the scope of the disclosure.

### Examples

### Example 1. Cold Cranking

Eight lithium ion batteries were prepared, all with lithium titanate anodes. Four of the batteries had lithium manganese oxide cathodes. Two of these four batteries had [E1] electrolyte and the other four had [E2] electrolyte. The composition of [E1] electrolyte was 1.0 M LiPF₆ in PC:EMC:EB (1:3:1, vol. %), while the composition of [E2] electrolyte was 1.0 M LiPF₆ in EC:EMC:EA (1:5:4, vol. %), where PC=propylene carbonate, EMC=ethyl methyl carbonate, EB=ethyl butyrate, EC=ethylene carbonate, and EA=ethyl acetate.

The other four batteries had lithium nickel manganese cobalt oxide cathodes. Again, two of these four batteries had [E1] electrolyte and the other two had [E2] electrolyte.

For the lithium manganese oxide (LMO) cathodes and lithium titanate (LTO) anodes, the composition was:

Ex. 1, wt. %

| Component | LMO | LTO |
|---|---|---|
| LMO or LTO | 88.5 | 89.5 |
| Carbon (SUPER P ®) | 4 | 3 |
| Graphite (TIMREX ® KS6) | 1.5 | 1 |
| Vapor-Grown Carbon Fiber | 3 | 1 |
| PVDF | 3 | 5.5 |

For the lithium nickel manganese oxide (NMC) cathodes and lithium titanate (LTO) anodes, the composition was:

Ex. 1, wt. %

| Component | NMC | LTO |
|---|---|---|
| NMC or LTO | 88.5 | 89.5 |
| Carbon (SUPER P ®) | 4 | 3 |
| Graphite (TIMREX ® KS6) | 1.5 | 1 |
| Vapor-Grown Carbon Fiber | 3 | 1 |
| PVDF | 3 | 5.5 |

In each of the batteries, the separator was CELGARD® 2325, which has a polypropylene/polyethylene/polypropylene construction, a thickness of 25 μm, and a porosity of 50±10%.

As noted above, two different electrolytes were used. These electrolytes were propylene carbonate based [E1] electrolyte and ethylene carbonate based [E2], described above.

The cold cranking test was performed according to USABC's cranking test at −30° C. (Battery Test Manual for 12 Volt Start/Stop Vehicles). The voltage limit for the LMO/LTO cells was 1.6V and the voltage limit for the NMC/LTO cells was 1.33V. The results are shown in Table 1.

TABLE I
Cold Cranking (−30° C. 80% SOC_40Ah Pack)

| Electrodes | Electrolyte | Cell No. | Pulse 1 | Pulse 2 | Pulse 3 |
|---|---|---|---|---|---|
| LMO/LTO | E1 | 1009 | 1.860 | 1.788 | 1.752 |
| | | 1012 | 1.850 | 1.776 | 1.738 |
| LMO/LTO | E2 | 1004 | 1.846 | 1.770 | 1.729 |
| | | 1007 | 1.836 | 1.759 | 1.717 |
| NMC/LTO | E1 | 1031 | 1.728 | 1.697 | 1.682 |
| | | 1033 | 1.728 | 1.695 | 1.679 |
| NMC/LTO | E2 | 1018 | 1.771 | 1.739 | 1.723 |
| | | 1021 | 1.744 | 1.711 | 1.694 |

Each cell number represents each individual cell that was tested. For example, for LMO/LTO with electrolyte [E1], there are two cells, Cell 1009 and Cell 1012.

The cold cranking was performed at 80% state of charge (SOC) (capacity 40 Ah).

“Pulse” means the 6 Kw discharge for 0.5 sec followed by 4 Kw discharge for 4 sec, which is the test procedure described in the USABC manual. In the manual, there are three consecutive pulses, which are separated by 10 sec. Therefore, these are presented in Table I as Pulse 1, Pulse 2 and Pulse 3. The results in Table I show that the battery has very good power performance at low temperatures.

### Example 2. Rate Performance

A lithium ion battery was prepared with LMO/LTO electrodes similar to Example 1, and a lithium ion battery was prepared with NMC/LTO electrodes similar to Example 1. The electrolyte was [E2] and the separator was CELGARD®2325, both described above in Example 1.

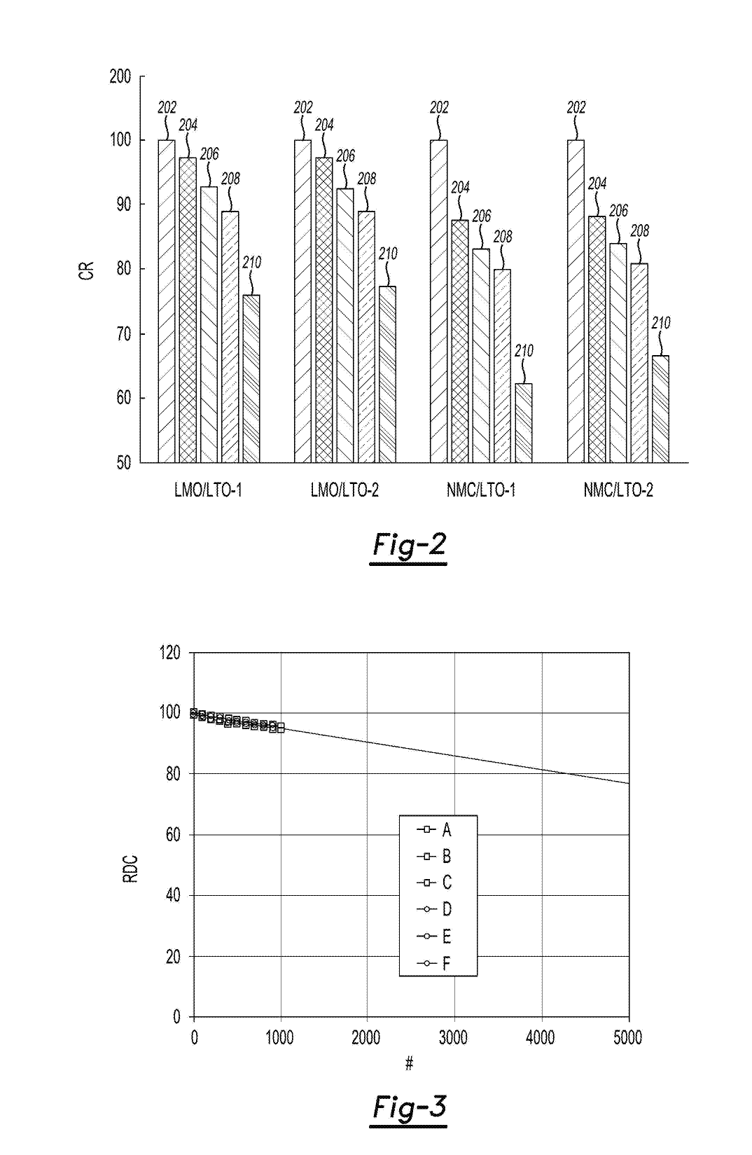

The batteries were 0.7 Ah cells. The discharge rate performance at 25° C. of the batteries was tested at different C-rates, namely 1 C, 10 C, 20 C, 30 C, and 50 C. The capacity retention (%, ratio versus 1 C) was determined. These results are shown in Table II and FIG. 2.

TABLE II
Discharge Rate Performance

| | | C-Rate | | | | |
|---|---|---|---|---|---|---|
| | | 1 | 10 | 20 | 30 | 50 |
| LMO/LTO-1 | ratio | 100.00 | 97.26 | 92.78 | 88.96 | 76.09 |
| LMO/LTO-2 | ratio | 100.00 | 97.17 | 92.47 | 88.78 | 77.48 |
| NMC/LTO-1 | ratio | 100.00 | 87.54 | 83.22 | 80.15 | 62.47 |
| NMC/LTO-2 | ratio | 100.00 | 88.29 | 83.93 | 80.96 | 66.80 |

The data are shown in FIG. 2, which is a plot 200 of percent of capacity retention for the two cells, measured twice (−1 and −2) at 1 C (labeled 202), 10 C (labeled 204), 20 C (labeled 206), 30 C (labeled 208), and 50 C (labeled 210). The capacity retention at higher C-rates (e.g., 10 C and 20 C) are better than or comparable with (i.e., within about 6% of) commercially available LTO cells.

### Example 3. Life Cycle

Six lithium ion batteries were prepared with LMO/LTO electrodes similar to Example 1. Three (A, B, C) were prepared with [E2] electrolyte, and the other three (D, E, F) were prepared with [E1] electrolyte, all using CELGARD® 2325 as the separator.

The life cycle of the batteries was tested for 1,000 cycles. The charging cycle condition was 5 C CC/CV charge to 2.7V at 45° C., 0.05 C cut-off and the discharging cycle condition was 10 C discharge to 1.5V at 45° C. The batteries were fully discharged to 100% DOD (depth of discharge). The recovery discharge capacity (%) versus the number of cycles (#) are shown in FIG. 3. Currently, the LMO/LTO cells have exhibited superior cycle life with 93 to 94% capacity retention after 2000 cycles with 5 C/10 C protocol at 45° C.

### Example 4. High Temperature Operation

High temperature data were obtained from cells having the composition listed in Example 1 for the NMC/LTO cells. The test conditions were: 70° C., 80% SOC (state of charge). No capacity loss was observed after 14 days storage (70° C. and 80% SOC). The measured data are depicted in Table III.

TABLE III
Calendar Life Test at 70° C., 80% SOC for 14 Days

| | | | | Capacity |
|---|---|---|---|---|
| | Initial Capacity | 14 Days Storage | | Retention - 14 |
| Cell | (Ah) | (Ah) | Capacity (%) | Days (%) |
| 1022 | 0.662 | 0.665 | 100 | 100.4 |
| 1023 | 0.658 | 0.659 | 100 | 100.2 |
| 1029 | 0.657 | 0.659 | 100 | 100.3 |
| 1036 | 0.653 | 0.655 | 100 | 100.2 |

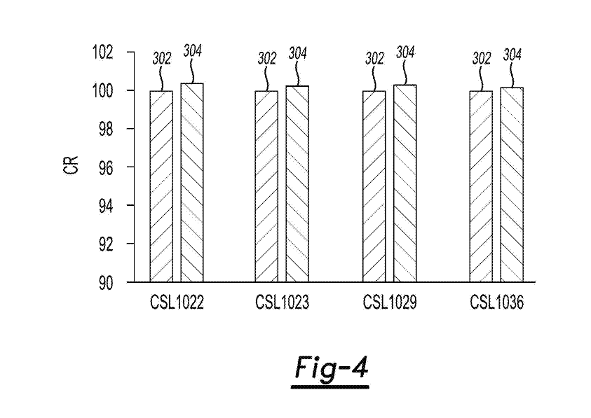

The data are also shown in FIG. 4, which is a plot of percent of capacity retention for the four cells, measured initially (labeled 302) and after 14 days (labeled 304). This data indicates that the electrodes disclosed herein are suitable for use at high temperature operations.

### Example 5. High Temperature Performance

Cells 1009 and 1012 (LMO/LTO electrodes, electrolyte [E1], CELGARD®2325 separator) from Example 1 were tested for high temperature (60° C.) performance.

The batteries were 0.66 Ah at 1 C cells. The discharge rate performance at 60° C. of the batteries was tested at different C-rates, namely 0.1 C, 1 C, 2 C, 5 C, 10 C, 20 C, and 30 C. The capacity retention (%, ratio versus 1 C) was determined. These results are shown in Table IV.

TABLE IV
Discharge Rate Performance

| | | C-Rate | | | | | | |
|---|---|---|---|---|---|---|---|---|
| Cell No. | | 0.1 | 1 | 2 | 5 | 10 | 20 | 30 |
| 1009 | Capacity, | 0.676 | 0.660 | 0.658 | 0.656 | 0.653 | 0.648 | 0.641 |
| | mAh | | | | | | | |
| | Ratio, % | 102.51 | 100.00 | 99.71 | 99.37 | 99.04 | 98.28 | 97.16 |
| | Avg. | 2.505 | 2.501 | 2.494 | 2.474 | 2.443 | 2.384 | 2.328 |
| | Voltage, V | | | | | | | |
| 1012 | Capacity, | 0.669 | 0.660 | 0.659 | 0.656 | 0.654 | 0.649 | 0.642 |
| | mAh | | | | | | | |
| | Ratio, % | 101.33 | 100.00 | 99.79 | 99.45 | 99.10 | 98.37 | 97.24 |
| | Avg. | 2.505 | 2.501 | 2.494 | 2.475 | 2.444 | 2.387 | 2.332 |
| | Voltage, V | | | | | | | |

The results in Examples 2 and 5 illustrate that the batteries disclosed herein exhibit suitable performance at both room temperature (25° C.) and at high temperature (60° C.). The data indicate that the LMO/LTO cells perform well at both temperatures, but the performance is slightly better at the higher temperature.

It is to be understood that the ranges provided herein include the stated range and any value or sub-range within the stated range. For example, a range from about 1.5V to about 5.0V should be interpreted to include not only the explicitly recited limits of about 1.5V to about 5.0V, but also to include individual values, such as 3V, 4.2V, etc., and sub-ranges, such as from about 3.1V to about 3.9V, etc. Furthermore, when “about” is utilized to describe a value, this is meant to encompass minor variations (up to ±10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A lithium ion battery, comprising:
a positive electrode including a positive electrode active material, wherein the positive electrode active material is selected from the group consisting of lithium manganese oxide, lithium nickel manganese cobalt oxide, and combinations thereof;
a negative electrode including lithium titanate; and
a polymer separator soaked in an electrolyte solution, the polymer separator being disposed between the positive electrode and the negative electrode.

2. The lithium ion battery as defined in claim 1 wherein:
the positive electrode active material is present in an amount ranging from about 85 wt. % to about 95 wt. % based on a total wt. % of the positive electrode; and
the lithium titanate is present in an amount ranging from about 85 wt. % to about 95 wt. % based on a total wt. % of the negative electrode.

3. The lithium ion battery as defined in claim 2, wherein each of the positive electrode and the negative electrode further includes:
a conductive filler, wherein the conductive filler is:
carbon present in an amount ranging from about 1 wt. % to about 6 wt. % based on the total wt. % of each of the positive electrode and the negative electrode individually;
graphite present in an amount ranging from greater than 0 wt. % to about 3 wt. % based on the total wt. % of each of the positive electrode and the negative electrode individually; and
vapor grown carbon fiber or carbon nanotubes present in an amount ranging from greater than 0 wt. % to about 5 wt. % based on the total wt. % of each of the positive electrode and the negative electrode individually; and
a binder present in an amount ranging from about 1 wt. % to about 8 wt. % based on the total wt. % of each of the positive electrode and the negative electrode individually, wherein the binder is chosen from polyvinylidene fluoride, polytetrafluoroethylene (PTFE), carboxymethylcellulose sodium and polymerized styrene butadiene rubber (CMC+SBR), acrylonitrile copolymers, and combinations thereof.

4. The lithium ion battery as defined in claim 1, wherein the lithium ion battery has a negative capacity to positive capacity ratio ranging from about 0.9 to about 1.05.

5. The lithium ion battery as defined in claim 1, wherein the positive electrode has a porosity ranging from about 25% to about 35% and the negative electrode has a porosity ranging from about 28% to about 44%.

6. The lithium ion battery as defined in claim 1, wherein:
the positive electrode active material is lithium manganese oxide and the positive electrode has a moisture content of less than 300 ppm or the positive electrode active material is lithium nickel manganese cobalt oxide and the moisture content is less than 500 ppm; and
the negative electrode has a moisture content less than 700 ppm.

7. The lithium ion battery as defined in claim 1, wherein the lithium ion battery has an operational temperature ranging from about −30° C. to about 70° C.

8. The lithium ion battery as defined in claim 1, wherein the positive electrode and the negative electrode each has an electric conductivity that is less than 2 Ω·cm.

9. The lithium ion battery as defined in claim 1, wherein the positive electrode active material is lithium manganese oxide and the positive electrode has a pressing density ranging from about 2.5 g/cm³ to about 2.9 g/cm³ or the positive electrode active material is lithium nickel manganese cobalt oxide and the positive electrode has a pressing density ranging from about 2.7 g/cm³ to about 3.1 g/cm³.

10. The lithium ion battery as defined in claim 1, wherein the negative electrode has a pressing density ranging from about 1.8 g/cm³ to about 2.2 g/cm³.

11. The lithium ion battery as defined in claim 1, wherein the lithium ion battery is a pouch battery, a prismatic battery, or a cylindrical battery.

12. The lithium ion battery as defined in claim 1, further comprising a positive electrode current collector and a negative electrode current collector, wherein each of the current collectors is aluminum foil.

13. The lithium ion battery as defined in claim 12, wherein the positive electrode current collector and the negative electrode current collector are carbon coated on at least one side.

14. The lithium ion battery as defined in claim 1, wherein:
the positive electrode further includes:
the positive electrode active material present in an amount ranging from about 85 wt. % to about 95 wt. % based on a total wt. % of the positive electrode;
a conductive filler including:
carbon present in an amount ranging from about 1 wt. % to about 6 wt. % based on s total wt. % of the positive electrode;
graphite present in an amount ranging from greater than 0 wt. % to about 3 wt. % based on the total wt. % of the positive electrode; and
vapor grown carbon fiber or carbon nanotubes present in an amount ranging from greater than 0 wt. % to about 5 wt. % based on the total wt. % of the positive electrode; and
a binder present in an amount ranging from about 1 wt. % to about 5 wt. % based on the total wt. % of the positive electrode, wherein the binder is chosen from polyvinylidene fluoride, polytetrafluoroethylene (PTFE), carboxymethylcellulose sodium and polymerized styrene butadiene rubber (CMC+SBR), acrylonitrile copolymers, and combinations thereof; and
the negative electrode further includes:
the lithium titanate present in an amount ranging from about 85 wt. % to about 95 wt. % based on a total wt. % of the negative electrode;
a conductive filler including:
carbon present in an amount ranging from about 1 wt. % to about 6 wt. % based on s total wt. % of the negative electrode;
graphite present in an amount ranging from greater than 0 wt. % to about 3 wt. % based on the total wt. % of the negative electrode; and
vapor grown carbon fiber or carbon nanotubes present in an amount ranging from greater than 0 wt. % to about 3 wt. % based on the total wt. % of the negative electrode; and
a binder present in an amount ranging from about 2 wt. % to about 8 wt. % based on the total wt. % of the negative electrode, wherein the binder is chosen from polyvinylidene fluoride, polytetrafluoroethylene (PTFE), carboxymethylcellulose sodium and polymerized styrene butadiene rubber (CMC+SBR), acrylonitrile copolymers, and combinations thereof.

15. A method of making a lithium ion battery, comprising:
forming a positive electrode slurry, wherein the positive electrode slurry includes a positive electrode active material present in an amount ranging from about 85 wt. % to about 95 wt. % based on a total solids wt. % of the positive electrode slurry, wherein the positive electrode active material is selected from the group consisting of lithium manganese oxide, lithium nickel manganese cobalt oxide, and combinations thereof;
forming a negative electrode slurry, wherein the negative electrode slurry includes lithium titanate present in an amount ranging from about 85 wt. % to about 95 wt. % based on a total solids wt. % of the negative electrode slurry;
wherein each of the positive electrode slurry and the negative electrode slurry further includes:
a conductive filler, wherein the conductive filler includes carbon, graphite and vapor grown carbon fiber or carbon nanotubes; and
a binder chosen from polyvinylidene fluoride, polytetrafluoroethylene (PTFE), carboxymethylcellulose sodium and polymerized styrene butadiene rubber (CMC+SBR), acrylonitrile copolymers, and combinations thereof;
coating the positive electrode slurry and the negative electrode slurry on a positive electrode current collector and a negative electrode current collector, respectively;
drying the positive electrode slurry and the negative electrode slurry, thereby forming a positive electrode and a negative electrode; and
adding a polymer separator soaked in an electrolyte solution between the positive electrode and the negative electrode, thereby forming the lithium ion battery.
